(19) United States
(12) Patent Application Publication
(10) Pub. No.: US 2018/0090304 A1
(43) Pub. Date: Mar. 29, 2018

(54) METHODS FOR CALIBRATION OF A QUADRUPOLE MASS FILTER

(71) Applicant: Thermo Finnigan LLC, San Jose, CA (US)

(72) Inventor: Bennett S. KALAFUT, San Jose, CA (US)

(73) Assignee: Thermo Finnigan LLC

(21) Appl. No.: 15/274,962

(22) Filed: Sep. 23, 2016

(51) Int. Cl. H01J 49/00; H01J 49/42

(52) U.S. Cl. CPC H01J 49/0009; H01J 49/0027; H01J 49/4215

(57) ABSTRACT

The linear relationship between physical mass-to-charge ratio and the location of a mass spectral peak along the DC/RF scan line of a quadrupole mass filter is used to simultaneously identify a known set of calibrants and to determine the correct slope and scaling of the scan line from a full spectrum scan of an uncalibrated instrument. This is achieved by using a method for image feature detection, to find a set of collinear peaks in a two-dimensional image constructed from scaled versions of the mass spectrum. The method for feature detection may include a Hough transform, Radon transform or other machine-vision technique.

### FIELD OF THE INVENTION

This invention relates, in general, to mass spectrometry and, more particularly, to calibration of quadrupole mass filter components of mass spectrometers.

### BACKGROUND OF THE INVENTION

Quadrupole mass filters are commonly employed for mass analysis of ions provided within a continuous ion beam. A quadrupole field is produced within the quadrupole apparatus by dynamically applying electrical potentials on four parallel rods arranged with four-fold symmetry about a long axis, which comprises an axis of symmetry that is conventionally referred to as the z-axis. FIG. 1 shows a schematic cross sectional view, taken in a plane perpendicular to the length of the four parallel rods, which, by convention, is taken as the x-y plane in Cartesian coordinates. The z-axis intersects the plane of the cross section at point 4. By convention, the four rods are described as a pair of “x-rods” 1 and a pair of “y-rods” 2. The “x-direction” or “x-dimension” is taken along a line connecting the centers of the x-rods. The “y-direction” or “y-dimension” is taken along a line connecting the centers of the y-rods.

The quadrupole rods are electrically coupled to a power supply 5 as illustrated in FIG. 1. The power supply 5 provides an oscillatory Radio Frequency (RF) voltage component of amplitude V to both pairs of rods and may also provide a non-oscillatory electrical potential difference, U, between the two pairs of rods. This non-oscillatory voltage component is often referred to as a “Direct Current” or DC voltage. As shown in FIG. 1, the electrical coupling between the power supply 5 and the rods 1, 2 is such that the RF phase on both x-rods is the same and differs by a 180 degrees (π) phase difference from the phase on the y-rods.

Upon introduction at an entrance of the quadrupole and into a trapping volume 3 between the rods, ions initially move inertially along the z-axis within the trapping volume entrance of the quadrupole. Only ions which pass completely through the quadrupole mass filter may be later detected by a detector, often placed at the exit of the quadrupole. Inside the quadrupole mass filter, ions have trajectories that are separable in the x and y directions. When both DC and RF voltages are applied to the rods, the applied RF field carries ions with the smallest mass-to-charge ratios out of the potential well and into the x-rods at which these ions are neutralized. Ions with sufficiently high mass-to-charge ratios remain trapped in the well and have stable trajectories in the x-direction; the applied field in the x-direction thus acts as a high-pass mass filter. Conversely, in the y-direction, only the lightest ions are stabilized by the applied RF field, which overcomes the tendency of the applied DC to pull them into the rods. Thus, the applied field in the y-direction acts as a low-pass mass filter. Ions that have both stable component trajectories in both x- and y-directions pass through the quadrupole to reach the detector.

In operation, the DC offset and RF amplitude applied to a quadrupole mass filter is chosen so as to transmit only ions within a restricted range of mass-to-charge (m/z) ratios through the entire length of the quadrupole. Depending upon the particular applied RF and DC potentials, only ions of selected m/z ratios are allowed to pass completely through the rod structures, whereas the remaining ions follow unstable trajectories leading to escape from the applied multipole field. The motion of ions within an ideal quadrupole is modeled by the Mathieu equation. Solutions to the Mathieu equation are generally described in terms of the dimensionless Mathieu parameters, “a” and “q”, which are defined as:

$$a = \frac{8 zeU}{{mr}_{0}^{2} {Ω}^{2}} ; q = \frac{4 zeV}{{mr}_{0}^{2} {Ω}^{2}} \qquad Eqs . 1$$

in which e is the magnitude of charge on an electron (taken here as a positive number), z is a dimensionless integer indicating the number of elemental charges on an ion, U is applied DC voltage, V is the applied zero-to-peak RF voltage, m is the mass of the ion, r is the effective radius between electrodes, and Ω is the applied RF frequency. General solutions of the Mathieu equation, i.e., whether or not an ion has a stable trajectory within a quadrupole apparatus, depend only upon these two parameters.

The solutions of the Mathieu equation, as known to those skilled in the art, can be classified as bounded and non-bounded. Bounded solutions correspond to trajectories that never leave a cylinder of finite radius, where the radius depends on the ion's initial conditions. Typically, bounded solutions are equated with trajectories that carry the ion through the quadrupole to the detector. Unbounded solutions are equated with trajectories that carry ions into the quadrupole rods or that otherwise eject ions before they traverse the entire length of the quadrupole. The plane of (q, a) values can be partitioned into contiguous regions corresponding to bounded solutions and unbounded solutions, as shown in FIG. 2. The region containing bounded solutions of the Mathieu equation is called a stability region and is labeled “X & Y Stable” in FIG. 2. A stability region is formed by the intersection of two regions, corresponding to regions where the x- and y-components of the trajectory are stable respectively. There are multiple stability regions, but conventional instruments involve the principal stability region, which is the only stability region shown in FIG. 2. By convention, only the positive quadrant of the q-a plane is considered. In this quadrant, the stability region resembles a triangle, as illustrated in FIG. 2.

Dashed and dashed-dotted lines in FIG. 2 represent lines of iso-βₓ and iso-β_{y}, respectively, where the Mathieu parameters βₓ and β_{y} are related to ion oscillation frequencies in the x- and y-directions, respectively. The region of ion-trajectory stability in the y-direction lies to the right of the curve labeled β_{y}=0.0 in FIG. 2, which is a bounding line of the stability region. The region of ion-trajectory stability in the x-direction lies to the left of the curve labeled βₓ=1.0 in FIG. 2, which is a second bounding line of the stability region. If an ion's trajectory is unstable in either the x-direction or the y-direction, then that ion cannot be transmitted through the quadrupole mass filter.

During common operation of a quadrupole for mass analysis (scanning) purposes, the instrument may be “scanned” by increasing both U and V amplitude monotonically to bring different portions of the full range of m/z values into the stability region at successive time intervals, in a progression from low m/z to high m/z. When U and V are each ramped linearly in time, the Mathieu points representing ions of various mass-to-charge ratios progress along the same fixed “scan line” through the stability diagram, with ions moving along the line at a rate inversely proportional to m/z. Two such scan lines are illustrated in FIG. 1. A first illustrated scan line 11 passes through the stability region boundary points 12 and 14. A second illustrated scan line 13 passes through the boundary points 16 and 18. The mass-to-charge values become progressively greater in progression from right to left along each scan line.

The width of the m/z pass band of a quadrupole mass filter decreases as the scan line is adjusted to pass through the stability region more closely to the apex, said apex defined by the intersection of the curves labeled β_{y}=0.0 and βₓ=1.0 in FIG. 2. During conventional mass scanning operation, the voltages U and V are ramped proportionally in accordance with a scan line that passes very close to the apex, thus permitting only a very narrow pass band that moves through the m/z range nearly linearly in time. Thus, during such conventional operation, the flux of ions hitting the detector as a function of time is very nearly proportional to the mass distribution of ions in a beam and the detected signal is a “mass spectrum”.

When a mass spectrum is generated by scanning of a quadrupole mass filter by means of proportional (or nearly proportional) linear ramping of DC and RF voltages, U and V, respectively, the plotted position of each ion species of a respective m/z value moves upward and to the right along the appropriate scan line. As the plotted points of ion species with smaller m/z values move into the “X Unstable” region, they are replaced by the plotted points of other ion species, having greater m/z values, as these points move out of the “Y Unstable” region and into the “X & Y Stable” region. Thus, the scan line regions within the stability field, such as the regions between points 12 and 14 or between points 16 and 18, comprise a range of m/z values and, thus, a range of ion species, that are stable within the quadrupole mass filter at any particular time. For best resolution, it is desirable to position the scan line close to the apex of the stability field.

Due to variability in manufacture of electrodes and control electronics and perturbations due to other ion optical devices the scan, the central masses and peak widths of a quadrupole mass filter at given U/V ratios of must be determined by empirical calibration. Accurate calibration of both the mass scale and the mass resolution must be performed in order to achieve accurate analysis of a sample by quadrupole mass spectrometry. Mass calibration allows the user to correctly identify analytes in the sample and reproducibly measure their abundances. Resolution calibration allows the user to select optimal peak widths for a given analysis either widening the peak width to improve sensitivity, or narrowing the peak width to improve specificity.

In practical terms, a calibration procedure determines a trajectory through RF-DC space that the operation of a quadrupole mass filter instrument must follow in order to generate a spectrum of uniform peaks of the desired width that are mapped to the correct m/z values. For this purpose, it is instructive to consider ion stability in terms of the actual applied DC and RF voltages, U and V, respectively, as shown in FIG. 3 instead of in terms of the general fully-parameterized Mathieu stability field diagram of FIG. 2. According to FIG. 3, ion stability within the quadrupole may be considered as being described by a continuum of overlapping stability field diagrams, one stability field diagram for each respective m/z value. FIG. 3 shows such a diagram in which stability field diagrams are shown for specific ion species of a hypothetical calibration mixture having m/z ratios of 195 Th (stability field 20a), 524 Th (stability field 20b), 1222 Th (stability field 20c), 1522 Th (stability field 20d) and 1822 Th (stability field 20e). Ions having such m/z-ratio values might be generated, for instance, by infusion of a calibration mixture into the ion source of a mass spectrometer. The reader should note that only the topmost portion of each of stability fields 20c, 20d, and 20e is illustrated in FIG. 3 so as to avoid a confusion of lines.

In the following discussion, it should be noted that references to a “mass-axis scale” refer to the typical abscissa employed in the depiction of mass spectra, the units of which are mass-to-charge ratio (usually denoted in m/z) Likewise, unless otherwise noted the terms “mass” and “mass position” refer to mass-to-charge values and/or position within an m/z scale. Calibration and verification rely on comparing observed values of mass position and peak width to a theoretical calibrant mass and requested peak width respectively. Thus, calibration scans must be performed. For instance, scan line 21 of FIG. 3 represents a scan line for a calibrated instrument. However, when calibrating an uncalibrated quadrupole ion filter, the actual scan line may be significantly different from an ideal scan line. For example, scan line 22 corresponds to a situation in which the rate of increase of the voltage, U, is too rapid in comparison to the rate of increase of the voltage, V, such that none of the ions are detected in a mass spectrum. Conversely, scan line 23 corresponds to a situation in which the rate of increase of the voltage, U, is too slow in comparison to the rate of increase of the voltage, V. In this second situation, although all ions are detected, the mass spectral peaks are too broad and severely overlap one another. Scan line 24 is similar to scan line 23 except the DC voltage is offset such that the projection of the scan line back to the U-axis intersects that axis at a non-zero value. In this third situation, the ions at 195 Th and 524 Th are not detected at all and the signals of the other three ions severely overlap. Scan line 25 corresponds to a situation in which the rate of increase of the voltage, U, is too rapid in comparison to the rate of increase of the voltage, V, and also in which the DC voltage is offset such that the projection of the scan line back to the V-axis intersects that axis at a non-zero value. In this latter situation, the mass spectrum comprises only a broad peak corresponding to the 524 Th and a shoulder corresponding to the 1222 Th ion. Thus, the identification or assignment of the peaks may be difficult when operating such initially mis-calibrated instruments.

Additionally, the beginning and end points of an initial scan of an uncalibrated apparatus may not be chosen correctly. For example if the end point of scan line 21 is at point 26a, then all five calibration peaks will be observed. However, if the end point is incorrectly set so that the scan ends at point 26b, then only four of the calibration peaks may be observed. Likewise the beginning and end points of any of the other hypothetical scan lines shown in FIG. 3 may be initially chosen such that fewer than the total expected number peaks are observed. Furthermore, if either of the beginning or end points cause at least part of the scan to be outside of the anticipated m/z range, then additional peaks may be detected that are not part of the calibration set.

Grothe (Grothe, Rob, “Mass and Resolution Calibration for New Triple-Stage Quadrupole Mass Spectrometers.” 61°st ASMS Conference Proceedings. 2013.) described a three-step quadrupole mass filter calibration including the steps of: (a) performing a coarse calibration during repeated scanning by adjusting the slope of the DC/RF scan line so as to bring all peaks into view, (b) calibrating the mass spectral resolution during repeated scanning by adjusting a DC offset of the scan line, and (c) adjusting the mass scale to correct mass positions along the scan. The outcome of each step can be understood in terms of the manipulations of the scan line position relative to the apex of the principal stability region of the Mathieu stability diagram as illustrated in FIG. 4. For simplicity, this figure shows just a single stability field corresponding to a particular m/z value. Scan line 31 represents a hypothetical initial scan of an uncalibrated apparatus. In step (a), the scan line is rotated into position (i.e., the slope of the line is adjusted) such that the rotated scan line 32 just intersects the apex of the stability field. This step comprises performing an adjustment of a first adjustable instrumental parameter, g. Although illustrated for just one stability field corresponding to just one particular m/z value, this step ideally causes the rotated scan line 32 to intersect the apices of stability fields corresponding to all m/z values. In step (b), only the voltage U is adjusted so as to move a portion of the scan line up or down relative to the stability field apex, as indicated by double arrow 36, so as to yield a desired resolution. The result of the adjustment is scan line 33. Both resolution and signal strength are affected by the closeness of scan line 33 to the apex. Positioning scan line 33 closer to the apex improves resolution but degrades signal strength. Finally, the mass scale is adjusted, in step (c), as indicated by double arrow 34, so as to map a correct m/z value to each point along the adjusted scan line. The portion of scan line 32 that cuts through the apex of the Mathieu diagram represents a pass band for ions of a certain m/z ratio. Each such passband is located at a respective position, s, along the scan line 32. The variable s is an instrumental variable that relates to the “distance” of the passband from the origin, where the origin corresponds to U=0 and V=0 and, in accordance with the Mathieu equations, also corresponds to hypothetical ions for which m/z=0 and. The variable, s, may be any instrumental variable for which the variation is linearly or approximately linearly related to the voltage U or the voltage, V, such as the voltage itself, a digital or analog control variable, etc.

In some cases, as described below, the variable, s, illustrated in FIG. 4 is, to a first approximation and for purposes of coarse calibration, proportional to voltage (either U or V). In practice, the variable, s, may be a digital or analog control signal or may be a quantity that is derivable from such a control signal. During the course of a mass scan, the instrumental variable is progressively varied and the passband (in terms of m/z) of ions transmitted through the quadrupole mass filter varies in response. A proper mass-axis calibration accurately maps the instrumental response to the imposed value of s and vice versa.

The calibration procedure described by Grothe first requires a user or technician to identify the calibrant peaks in an uncalibrated spectrum and to determine the proper setting of the adjustable parameter, g, that corresponds to a straight scan line through the origin (e.g., scan line 32) that yields a narrow and approximately constant peak width. Once a user has identified the peaks, a curve fitting procedure is employed during the either the step (b) or the step (c) or both, using the known line positions and isotopic variants, to determine the precise locations and widths of the peaks. A user or technician must therefore rely on experience to recognize peaks by eye based on their relative positions and intensities. If the user can positively identify at least two peaks, then automatic iterative linear extrapolation can be employed to extend the scan range to encompass other peaks. This linear extrapolation procedure determines, at each step, a local scan window in which to search for additional strong peaks. Unfortunately, given the wide variety of forms of initial mass spectra that might be obtained during the making of an initial scan by an uncalibrated apparatus (e.g., curves 21-25 of FIG. 3), it may be difficult for a user or technician to determine the identities of the peaks. Both the human operator and the automated linear extrapolation procedure can be misled by the presence of contaminant peaks within local scan windows or anywhere near the first two identified peaks. Moreover, the procedure described by Grothe relies on precise determination of the apparent m/z ratios of the various observed peaks by peak fitting, which can be difficult to perform if the peak shapes are different from an assumed shape, the peaks are broad, there is a slowly varying baseline signal, or the signal is weak, all of which are frequent problems with uncalibrated mass spectrometers. Accordingly, there is a need in the mass spectrometer calibration art for an improved method to positively identify peaks of known calibrant materials when performing a calibration of an uncalibrated mass spectrometer.

### SUMMARY OF THE INVENTION

In order to address the above-noted need in the art, the new method described herein makes use of the general property that, for a quadrupole mass filter, a simple linear mapping may be sufficient to transform observed (incorrect) m/z values into correct m/z values. In accordance with the present teachings, this expected property is used in a global way to simultaneously positively identify calibrant peaks and generate a mass-axis calibration with less vulnerability to the presence of interfering peaks and less reliance on the ability to positively identify any single peak on its own.

In accordance with a first aspect of the present teachings, a method for performing a calibration of the mass-to-charge (m/z) values of mass spectra generated by a quadrupole mass filter is provided, the method comprising: (a) infusing a calibrant material into the mass spectrometer, wherein the calibrant material comprises a compound or a mixture compounds known to generate C mass spectral peaks at respective known m/z values; (b) generating an uncalibrated mass spectrum of the calibrant material comprising P observed mass spectral peaks, where P°>° C., (c) calculating, for each known calibrant m/z value, a set of P assumed values of a control parameter, s, that is used to control m/z values of ions transmitted through the quadrupole mass filter, wherein each assumed value corresponds to a respective one of the observed mass spectral peaks and is calculated under an assumption that said observed mass spectral peak corresponds to said known calibrant m/z value; (d) logically assembling a scatter plot of a plurality of points, each point having a coordinate representing a known m/z value and another coordinate representing a one of the assumed s values calculated for the known m/z value; (e) finding a straight line that passes, within error, through the origin of the scatter plot and through exactly one point of the scatter plot at each known m/z value; and (f) determining a calibration parameter from the slope of the straight line.

In accordance with some embodiments, the logical assembling of the scatter plot includes generating a physical plot of the plurality of points and the finding of the straight line includes orienting a straight edge to align with the scatter plot origin and with exactly one point at each known m/z value. In accordance with some other embodiments, the logical assembling of the scatter plot may comprise storing, in computer readable memory, an array or data structure mathematically representing the positions of the points of the scatter plot in a two dimensional data space and the finding of the straight line includes mathematically analyzing the array or data structure using a machine-vision straight-line-finding algorithm. In some such embodiments, the machine-vision straight-line-finding algorithm may comprise calculating a Hough transform or a Radon transform of the positions of the points. In accordance with some other embodiments, the logical assembling of the scatter plot may comprise storing, in computer readable memory, an array mathematically representing the positions of the points of the scatter plot in a two dimensional data space and the finding of the straight line comprises: (i) calculating, for each pair of first and second known m/z values and for a plurality of pairs of the points, each pair of points consisting of one point associated with the first m/z value and one point associated with the second m/z value, a slope and an axis intercept of a line passing through the pair of points; (ii) for those pairs of points for which the axis intercepts pass through the origin, within error, generating a histogram representing the number of times a slope value is calculated within each of a number slope ranges; and (iii) determining the straight line as a line through the scatter plot origin having a slope corresponding to the histogram maximum value.

In accordance with a second aspect of the present teachings, a method for performing a calibration of the mass-to-charge (m/z) values and widths of peaks of mass spectra generated by a quadrupole mass filter is provided, the method comprising: (a) infusing a calibrant material into the mass spectrometer, wherein the calibrant material comprises a compound or a mixture compounds known to generate C mass spectral peaks at respective known m/z values; (b) generating an uncalibrated mass spectrum of the calibrant material comprising P observed mass spectral peaks, where P°>° C., (c) calculating, for each known calibrant m/z value, a set of P assumed values of a control parameter, s, that is used to control m/z values of ions transmitted through the quadrupole mass filter, wherein each assumed value corresponds to a respective one of the observed mass spectral peaks and is calculated under an assumption that said observed mass spectral peak corresponds to said known calibrant m/z value; (d) logically assembling a scatter plot of a plurality of points, each point having a coordinate representing a known m/z value and another coordinate representing a one of the assumed s values calculated for the known m/z value; (e) finding a straight line that passes through the origin of the scatter plot and through exactly one point of the scatter plot at each known m/z value; (f) determining a coarse calibration parameter from the slope of the straight line; (g) adjusting a control parameter that controls a ratio of voltages, U/V, applied to the quadrupole mass filter to a value such that a mass spectrum obtained subsequent to the adjustment comprises approximately constant peak widths; (h) adjusting the voltage, U, applied to the quadrupole mass filter such that a mass spectrum obtained subsequent to the U adjustment comprises constant peak widths; and (j) generating a final m/z calibration by adjusting the control parameter, s, such that a mass spectrum obtained subsequent to the s adjustment fits a model spectrum, wherein the model spectrum employs the coarse calibration to identify peaks. The steps (a) through (f) may comprise an initial coarse calibration of m/z values of peaks of mass spectra generated by the quadrupole mass filter and the additional steps (g) through (j) may comprise a fine calibration of both m/z values and widths of peaks of mass spectra generated by the quadrupole mass filter.

### BRIEF DESCRIPTION OF THE DRAWINGS

The above noted and various other aspects of the present invention will become apparent from the following description which is given by way of example only and with reference to the accompanying drawings, not drawn to scale, in which:

FIG. 1 is a schematic cross sectional view of rods of a quadrupole mass filter, showing electrical connections to a power supply;

FIG. 2 is a Mathieu stability region diagram, plotted on parameterized scales, as pertaining to the general operation of quadrupole mass filters;

FIG. 3 is a plot of a series of schematic partial Mathieu stability region diagrams, each pertaining to stability of a different calibrant ion within a quadrupole mass filter, as plotted in U-V space, where U represents the magnitude of a “Direct Current” (DC) voltage applied to the quadrupole and V represents the amplitude of a Radio Frequency (RF) oscillatory voltage applied to the quadrupole, the plot further showing various hypothetical scan lines corresponding to uncalibrated and calibrated operation of the quadrupole mass filter;

FIG. 4 is a schematic partial Mathieu stability region diagram illustrating various hypothetical scan lines corresponding to steps in a known procedure for calibrating a quadrupole mass filter;

FIG. 5A is a diagram showing transformation of general x, y Cartesian coordinates into the coordinates ρ and θ in accordance with a Hough transform;

FIG. 5B is a schematic diagram illustrating the manner by which collinear points may be recognized by a Hough transform procedure;

FIG. 6A is plot of adjusted instrumental mass scale settings against assumed mass-to-charge ratios, showing an exemplary graphical method, in accordance with the present teachings, for identifying mass spectral peaks corresponding to known calibrant ion mass-to-charge (m/z) ratios and for developing a calibration that maps values of an instrumental variable to the m/z values;

FIG. 6B is a schematic depiction of an automated histogram tabulation method, in accordance with the present teachings, for identifying mass spectral peaks corresponding to known calibrant ion m/z ratios and for developing a calibration that maps values of an instrumental variable to the m/z values;

FIG. 6C is a schematic illustration of how calibration methods in accordance with the present teachings may be extended, by translation of axes, to the generation of a linear calibration when a calibration line does not pass through an axes origin but a single point on the calibration line is definitively known;

FIG. 7A is an exemplary flow diagram of a method, in accordance with the present teachings, for calibrating a quadrupole mass filter; and

FIG. 7B is an exemplary flow diagram of a method, in accordance with the present teachings, for automatically deriving a calibration of m/z of mass spectra obtained with a quadrupole mass filter.

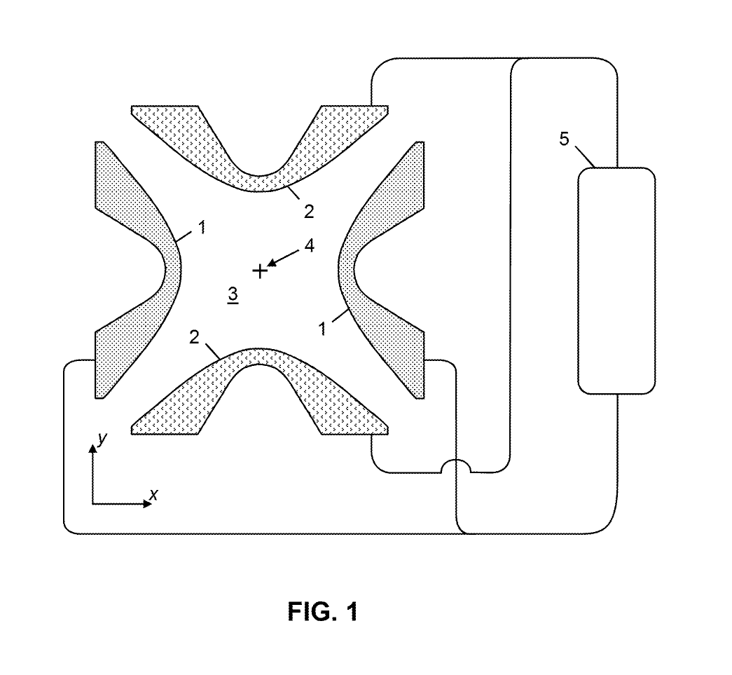

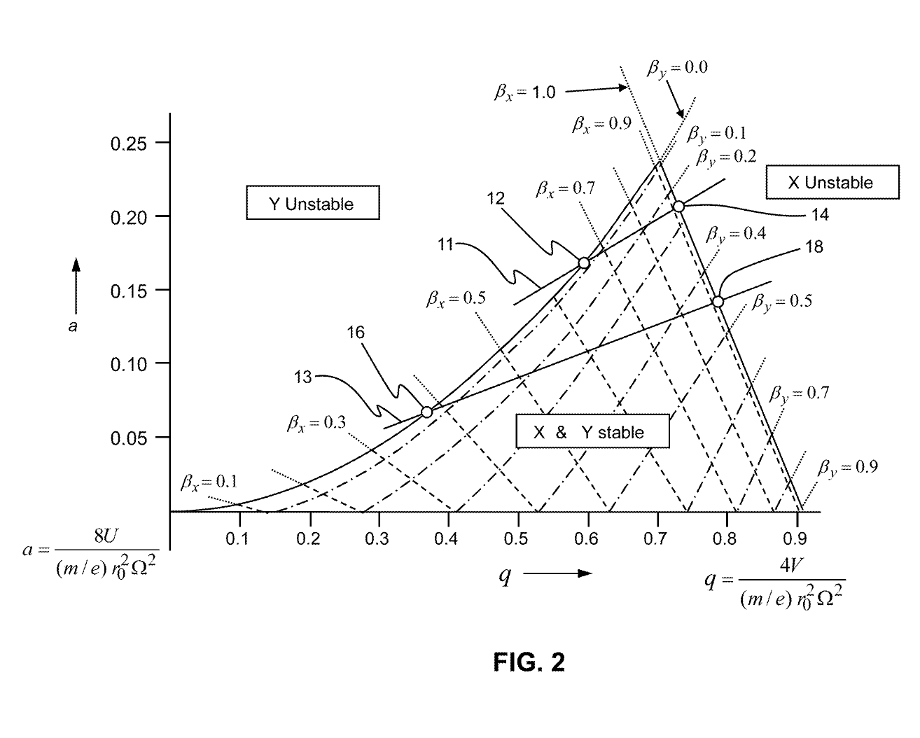

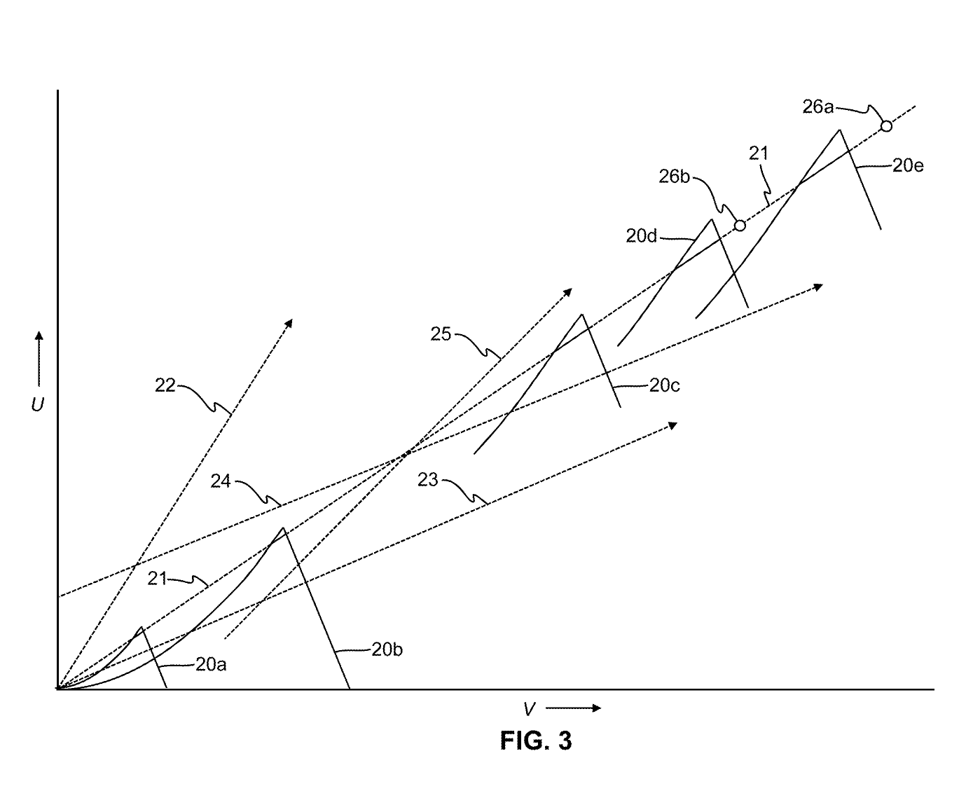

### DETAILED DESCRIPTION

The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. The particular features and advantages of the invention will become more apparent with reference to the appended figures taken in conjunction with the following description.

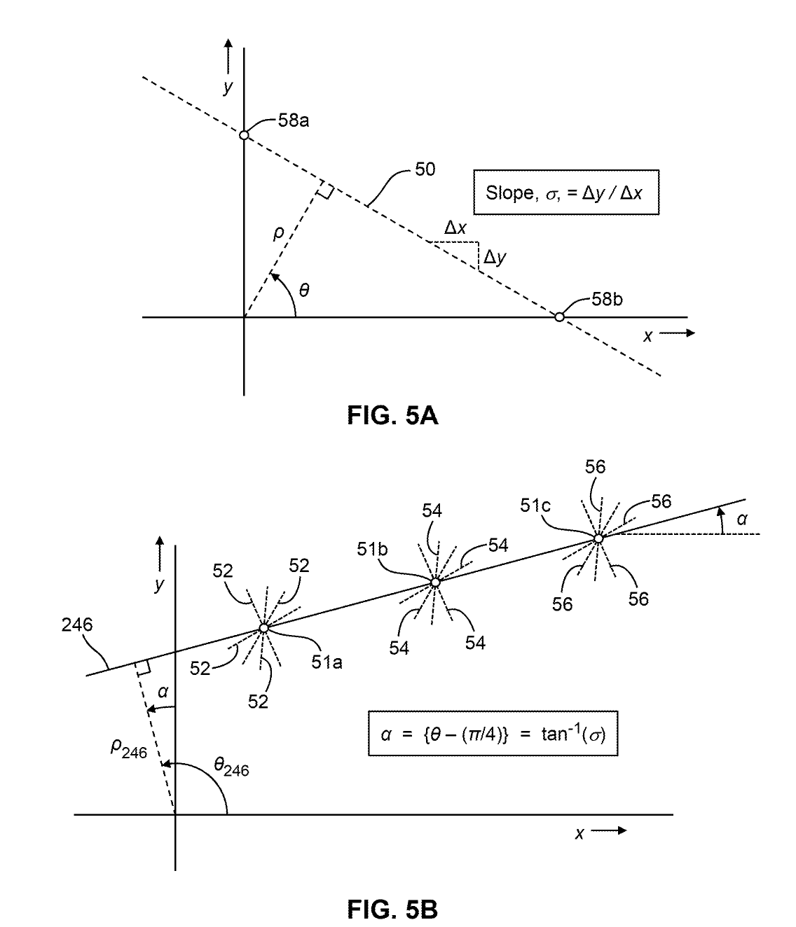

In order to calibrate a mass scale of a quadrupole mass filter, a simple linear mapping may be sufficient to transform observed (uncalibrated) m/z values into calibrated m/z values. The inventor has therefore realized that machine-vision techniques may be employed in order to efficiently recognize sets of data points that comprise a linear trend. One such technique makes use of the Hough transform (U.S. Pat. No. 3,069,654 in the name of inventor Hough; see also Duda, R. O. and P. E. Hart, “Use of the Hough Transformation to Detect Lines and Curves in Pictures,” Comm. ACM, Vol. 15, pp. 11-15, 1972), which is used for detecting simple shapes in digital images. According to the Hough transform, a line in ordinary two-dimensional Cartesian coordinate space (e.g., the x-y plane) is represented as a point having the coordinates θ and ρ in a two-dimensional Hough space. FIG. 5A graphically illustrates how the coordinates ρ and θ are determined for a given line in the x-y plane. As shown in FIG. 5A, ρ is the distance from the origin to the closest point on the line, and θ is the angle between the axis and the line connecting the origin with that closest point. The coordinates θ and ρ may be determined from any known two of the y-intercept of the line represented as point 58a, the x-intercept of the line represented as point 58b and the slope of the line, σ, where σ=Δy/ΔX as shown.

Given a single point in the x-y plane, then the set of all straight lines going through that point corresponds to a sinusoidal curve in the (θ, ρ) plane, which is unique to that point. FIG. 5B illustrates a set of three collinear points, 51a, 51b and 51c that all lie along the line 246 in the x-y plane. FIG. 5B also schematically illustrates the set of all straight lines 52 in the x-y plane that pass through the first point 51a, the set of all straight lines 54 in the x-y plane that pass through the second point 51b and the set of all straight lines 56 in the x-y plane that pass through the third point 51c. By the properties of the Hough transform, each set of such straight lines corresponds to a respective unique sinusoidal curve in the (θ, ρ) plane. Also, since line 246 passes through all three points, line 246 belongs to each set of lines: lines 52, lines 54, and lines 56. Accordingly, the separate sinusoidal curves in Hough space must all intersect at a common point (θ₂₄₆, °ρ₂₄₆), whose inverse Hough transform yields parameters describing the position of the line 246.

As a practical matter, curves in Hough space and inverse Hough transforms are not generally calculated. Instead various pairs of points, p1 and p2, in a scatter plot of data is allowed to cast a “vote” for a unique point (θ_{p1,p2}, °ρ_{p1,p2}) in Hough space. The votes from the various pairs of points are tabulated in a histogram and the histogram bin with the greatest number of votes is taken as representing the Hough-space intersection point. The data points whose votes are tabulated in this most-populated bin are then taken as the subset of the original data points that are the most collinear.

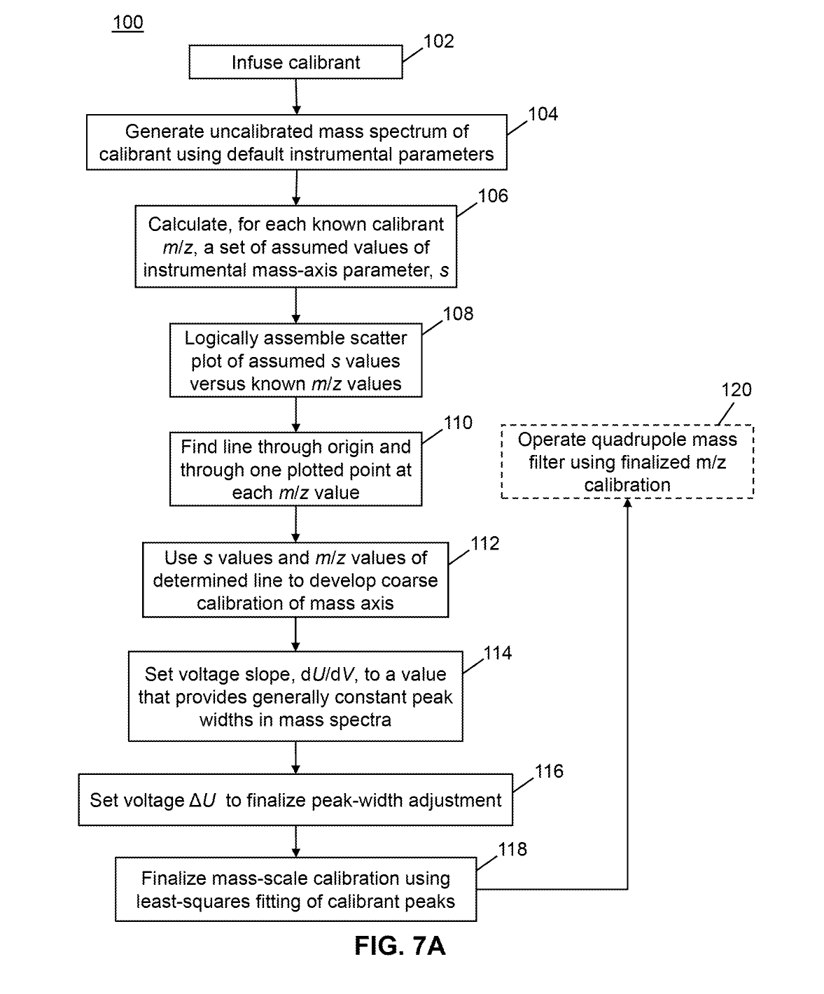

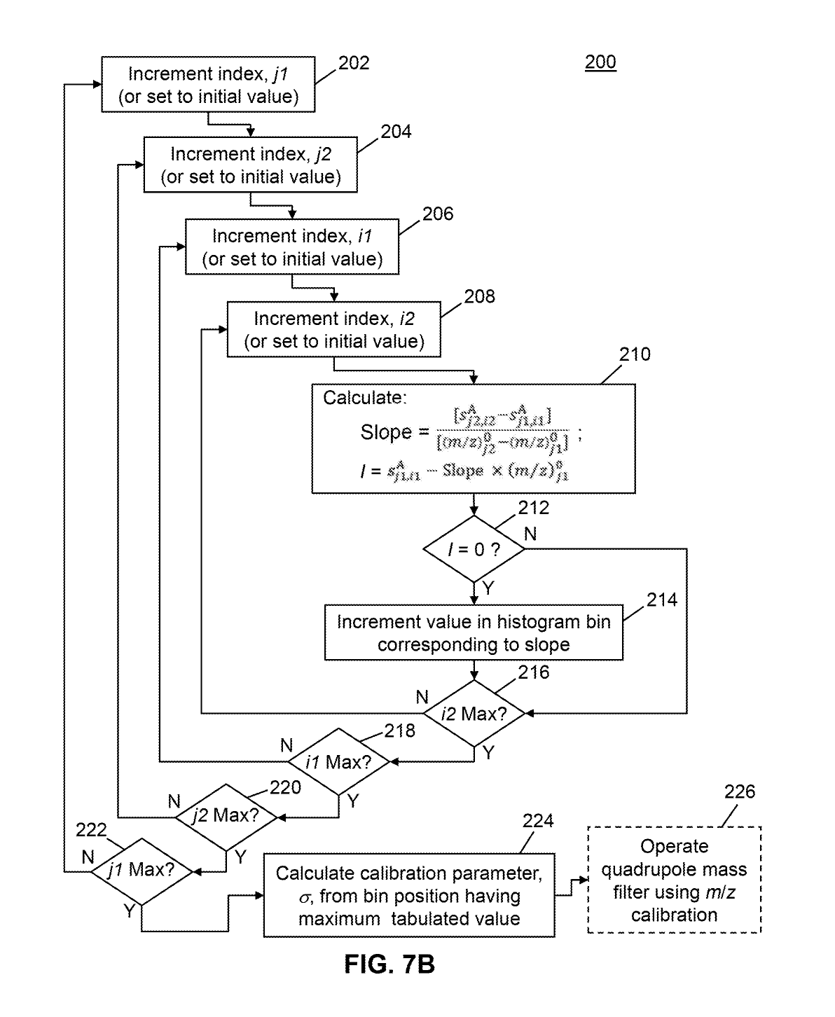

The following discussion as well as the method 100 depicted in FIG. 7A and the method 200 depicted in FIG. 7B describe calibration procedures for mass spectrometer comprising a quadrupole mass filter, wherein the calibration procedures make use of the Hough transform in a way that overcomes the aforementioned difficulties of positively identifying peaks displayed in an uncalibrated mass spectrum. As a first step, a known calibrant mixture is infused into the mass spectrometer (e.g., Step 102 of method 100). The calibrant mixture is formulated or chosen so as to yield a total number, C, of mass spectral peaks whose m/z values are a priori known. The set, S⁰, of m/z values of known calibrant peaks, also referred to as expected peaks, may be represented as

S⁰≡{(m/z)₁⁰,(m/z)₂⁰, . . . ,(m/z)ⱼ⁰, . . . ,(m/z)_{C}⁰},1≦j≦C Eq. 2

In the above representation, the various (m/z)⁰ values are ordered as a sequence of progressively increasing values.

Next, a full uncalibrated mass spectrum of the mixture is obtained (Step 104) by scanning along a scan line of which an initial voltage slope, ΔU/ΔV, and an initial mapping, from scan line position, s, to m/z are set to default pilot values, based on prior experience. The pilot values are chosen such that at least all of the C calibrant peaks are visible in the entire mass range of interest and such that the mapping provides at least an approximation to a linear relationship between the scan line position, s, and m/z values (as yet uncalibrated). This initial mass spectrum provides a record of a total number P of observed peaks (P≧C), each peak corresponding a respective s value at and a respective uncalibrated m/z value at which the peak is observed. The set, S^{s-obs}, of s values and the set, S^{m-obs}, of m/z values of the observed peaks in the uncalibrated mass spectrum may be represented as

S^{s-obs}≡{s₁^{obs},s₂^{obs}, . . . ,sᵢ^{obs}, . . . ,s_{P}^{obs}},1≦i≦P;P≧C Eq. 3

S^{m-obs}≡{(m/z)₁^{obs},(m/z)₂^{obs}, . . . ,(m/z)ᵢ^{obs}, . . . ,(m/z)_{P}^{obs}},1≦i≦P Eq. 4

In the above representations, the various s^{obs} values are ordered as a sequence of progressively increasing values and the various (m/z)^{obs} values are ordered as another sequence of progressively increasing values.

In the next step (Step 106 of the method 100), a respective set of assumed values of the instrumental mass-axis parameter, s, are calculated for each known calibrant m/z. For each known calibrant m/z, there are a total of P assumed values of s, with each such assumed value corresponding to a one of the observed peaks in the uncalibrated mass spectrum. The calculation of each i^{th} one of the P assumed s values at each value of j (corresponding to known mass-to-charge value (m/z)ⱼ⁰) is made under the assumption that the observed mass spectral peak that corresponds to the assumed s value is, in fact, the calibrant peak that actually occurs at position (m/z)ⱼ⁰ (thus, each (m/z)ⱼ⁰ value may be regarded as an assumed mass-to-charge value). In reality, when the experiment is designed such that all calibrant peaks are detected, this assumption is true for exactly one such peak at each j value. At each j value, each i^{th} assumed s value, may be simply calculated from the observed s value, sᵢ^{obs}, the assumed mass-to-charge value, (m/z)ⱼ⁰ and the observed mass-to-charge value, (m/z)ᵢ^{obs}. Accordingly, a total of P×C such assumed values, s_{i,j}^{A}, are calculated. The set of assumed values may be represented as a matrix, S, namely:

S_{(P×C)}=[s_{i,j}^{A}] Eq. 5

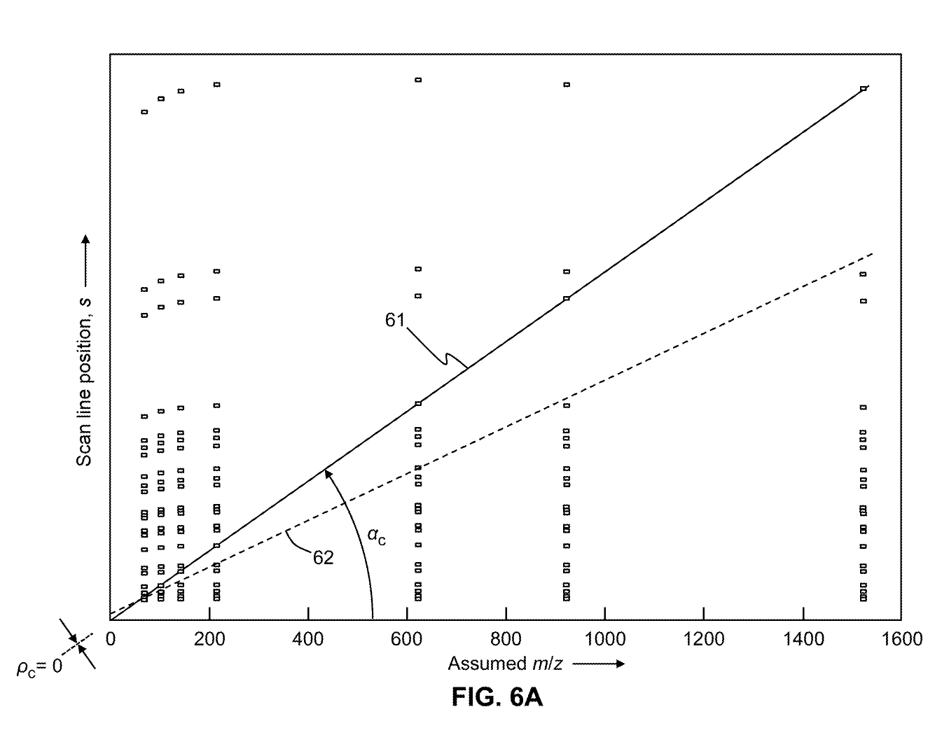

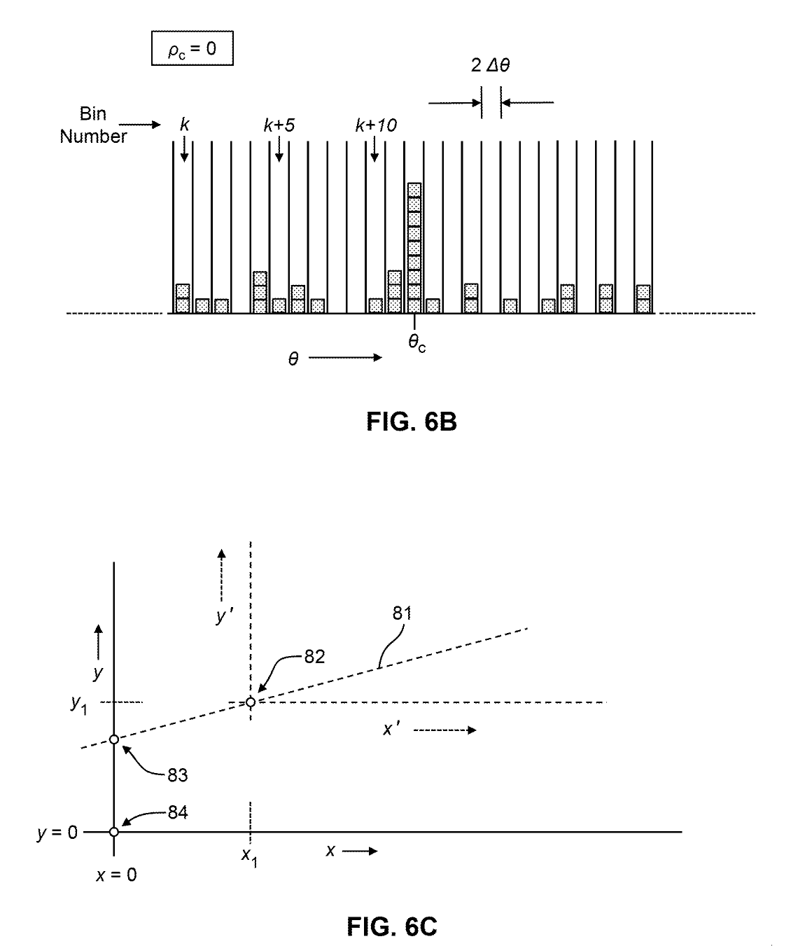

After the P×C assumed values, s_{i,j}^{A}, have been calculated, the C known calibrant m/z values and the P observed s values are logically assembled into a scatter plot (Step 108 of the method 100) as illustrated in FIG. 6A in which assumed m/z is plotted along the abscissa and assumed s is plotted along the ordinate. The term “logically assembled” as used here includes but does not necessarily require the generation of either a physical plot (such as on paper) or a virtual plot (as on a computer monitor). As used here, the term “logically assembled” may also include an abstract logical representation of the scatter plot in computer memory, such as by a two-dimensional array or matrix or a data structure. For example, the scatter plot in FIG. 6A includes (P×C) points, which may be taken as a graphical depiction of the elements of the matrix, S, defined in Eq. 5. Specifically, for each one of the C known calibrant m/z values, a separate point is plotted for each and every one of the P observed peaks under the assumption that each observed peak corresponds to the known m/z value. Thus, as shown in FIG. 6A, the points of the scatter plot assume the form of C columns of points, where each of the P points in each column corresponds to one of the observed peaks. The abscissa value of each column is thus an assumed m/z for each and every one of the peaks in the column, which is, of course, true for exactly one of the peaks.

In order to identify the subset of the data which may be used to develop a mass-axis calibration, each of the known calibrant m/z values is matched to its correct corresponding plotted point (Step 110 of the method 100). If a physical plot is used, this matching may be performed by finding a straight line that includes a single point from each column and that also passes through the origin (within point plotting error, in each case), as is illustrated by line 61 in FIG. 6A. Then, each point along the line is one of the known calibrant peaks, and the ordinate of the point is the value of the instrumental mass scale that must be applied in order for the position of the peak on the mass scale to be calibrated. This procedure correctly identifies the calibrant peaks because the instrumental mass-axis variable, s, when properly scaled, must be nearly proportional to m/z and must pass through the origin by virtue of the Mathieu equations (Eqs. 1). It should be noted that, at this point, the calibration may be only a coarse calibration and not a final calibration if mass spectral m/z values are not strictly linear in terms of the instrumental control variable, s. The correct calibration line 61 is readily distinguishable from other, slightly offset lines, such as the incorrect line 62, because these will either fail to pass through the origin or fail to include a point from each vertical column.

The calibration line 61 plotted in FIG. 6A was found graphically by use of a straightedge, varying its angle and offset and counting peaks, without knowing the identity of the correct calibrant peaks. This procedure is the analog, human-driven way of computing the Radon transform, which is employed in tomography and is mathematically (but not computationally) identical to the Hough transform. All such variations, including both analog versions and digital machine-vision versions of identifying calibrant peaks as exemplified by the line 61 are considered to be within the scope of the present invention.

Alternatively, the method 200 set forth in FIG. 7B is a flow chart of an automated procedure for accomplishing the same result as provided by Step 110 in the method 100 (FIG. 7A). Using the notation set forth in Eqs. 3-5, the automated search for a closest-matching straight line may step through the index, j1, where 1≦j1≦(C−1) (Step 202 of method 200 in FIG. 7B) and, for each value of the index j1, then step through the index j2, where j1<j2≦C (Step 204). In either Step 202 or Step 204, an index (j1 or j2) is set to its respective initial value upon the very first execution of the step or if the index is already at its maximum value; otherwise, the index is incremented. This procedure is equivalent to considering, in turn, each pair of vertical columns of plotted points of FIG. 6A. The stepping through the indices is performed such that each possible pairing of columns is considered exactly one time. Then, for each such (j1, °j2) pair, the index i1 is stepped through each of its values given by 1≦i1≦P (Step 206) and, for each (j1, °j2, i1) triplet, the index i2 is stepped through each of its values, 1≦i2≦P (Step 208). In either Step 206 or Step 208, an index (i1 or i2) is set to its respective initial value upon the very first execution of the step or if the index is already at its maximum value; otherwise, the index is incremented. For each quadruplet of indices (j1, °j2, i1, i2) the slope and s-intercept of a line passing through the pair of points, p1 and p2, where p1≡((m/z)ⱼ₁⁰, s_{j1,i1}^{A}) and p2≡((m/z)ⱼ₂⁰, s_{j2,i2}^{A}) are calculated (Step 210) as:

$$Slope = \frac{[ {s}_{j 2 , i 2}^{A} - {s}_{j 1 , i 1}^{A} ]}{[ {( m / z )}_{j 2}^{0} - {( m / z )}_{j 1}^{0} ]} \\ Intercept = {s}_{j 1 , i 1}^{A} - Slope \times {( m / z )}_{j 1}^{0} \qquad Eqs . 6$$

The above computations are equivalent to considering the points of FIG. 6A in pairs, each pair comprising a first point at a first assumed m/z value, (m/z)ⱼ₁⁰ and a second point at a second assumed m/z value, (m/z)ⱼ₂⁰. For each such pair of points, the slope and s-intercept of an extended line that passes through the points is calculated. If the s-intercept of the line is not zero, within error (determined in Step 212), then no tabulation is made with regard to the pair of points. However, if the s-intercept of the line is zero, within error, then the a tabulation is made (Step 214), in an appropriate bin of a histogram, of the occurrence of that slope value, as is schematically illustrated in FIG. 6B. Note that the slope value corresponds to the angle, α, as identified in FIG. 5B. This angle is related to the Hough angle, θ, by θ=α+π/4. Although it is more convenient to tabulate in terms of the angle, α, nonetheless, the histogram and this discussion are presented in terms of the Hough angle, θ. Specifically, if the determined Hough angle, θ, is such that (θₖ−Δθ/2)<θ≦(θₖ+Δθ/2), where Δθ is either a maximum experimental uncertainty of slope calculation or possibly an arbitrary number, then a counter in bin k of the histogram is incremented (see FIG. 6B). The value of the slope, σ, that is to be used to formulate the mass axis calibration is determined from θ_{C}, which is found from the bin having the maximum tabulated value (Step 224). Accordingly, in the (possibly coarsely) calibrated mass axis, m/z=(1/σ)×s, (or, equivalently, (m/z)=α×s where α°=°(1/σ) where s is the instrumental variable.

Step 216 of the method 200 is a decision step in which the index i2 is compared to its maximum permissible value (P). If the index i2 is not yet at its maximum value (the “N” or “NO” branch of Step 216), then execution of the method returns to Step 208 at which the value of i2 is incremented and after which Steps 201, 212 and 214 are reiterated using the newly incremented value of i2. Otherwise (the “Y” or “YES” branch of Step 216), execution passes from Step 216 to Step 218. Subsequent Steps 218, 220 and 222 are similar decision steps which compare the indices i1, j2 and j1 to their respective maximum permissible values. In each such step, if the index under consideration is less than its maximum permissible value, then execution of the method 200 returns back to a step at which the index is incremented (i.e., one of Steps 208, 206 and 204); otherwise execution proceeds forward to the next step. Once the index j1 has attained its maximum value, the Step 224 is executed. If this mass-axis calibration is a coarse calibration that is part of a full calibration of mass-scale and peak widths (for instance, having entered the method 200 from step 108 of the method 100), then the method 200 may exit to Step 114 of the method 100 (which step is subsequently executed). However, if the calibration determined in Step 224 is the only calibration or a final calibration (see following paragraph), then the quadrupole mass filter may be operated to obtain mass spectra of samples using this calibration (Step 226).

Although the above analysis and mathematical treatment has been presented within a preferred context of providing a coarse mass-axis calibration from an instrumental variable, s, to an instrumental response variable, m/z, under the assumption that the correct calibration may be represented by a line through the origin this treatment may be generalized to generating a calibration of any portion of the mass axis, not necessarily a coarse calibration, if it may be assumed that the calibration is linear over that portion and provided that a single peak or feature can be positively identified. Moreover, with such an assumption and constraint, this procedure may be further generalized beyond the field of mass spectrometry to linear calibration of any instrumental response variable, y, in terms of an instrumental control variable, x, as is schematically illustrated in FIG. 6C. With reference to FIG. 6C, let line 81 represent the hypothetical correct linear calibration relationship between variable x and variable y. In this example, the calibration line does not pass through the origin point 84 but instead intercepts the y-axis at y-intercept point 83. Such a response might occur for a quadrupole mass filter, for example, as a result of various perturbations or imperfections relative to an ideal quadrupole field or instrumental drift. However, if the coordinates, (x₁, y₁) of one known reference point 82 are available, then a translation of the axes from the (x, y) reference from to a new (x′, y′) reference frame can be employed to shift the origin to the position of the known reference point 82. All calculations may then be performed, exactly as previously described, in terms of the primed variables x′=(x−x₁) and y′=(y−y₁) so as to determine the slope of the calibration line 81. A reverse transformation back to the original variables (x, y) then yields the correct calibration parameters. The known reference point 82 may relate to a single distinctive peak of a calibrant material that may be readily identified, on its own, by virtue of a distinctive intensity, peak shape, or peak splitting. Alternatively, the known reference point 82 may relate to a distinctive peak of a common contaminant or background material that is universally or often present in samples or in an ambient environment.

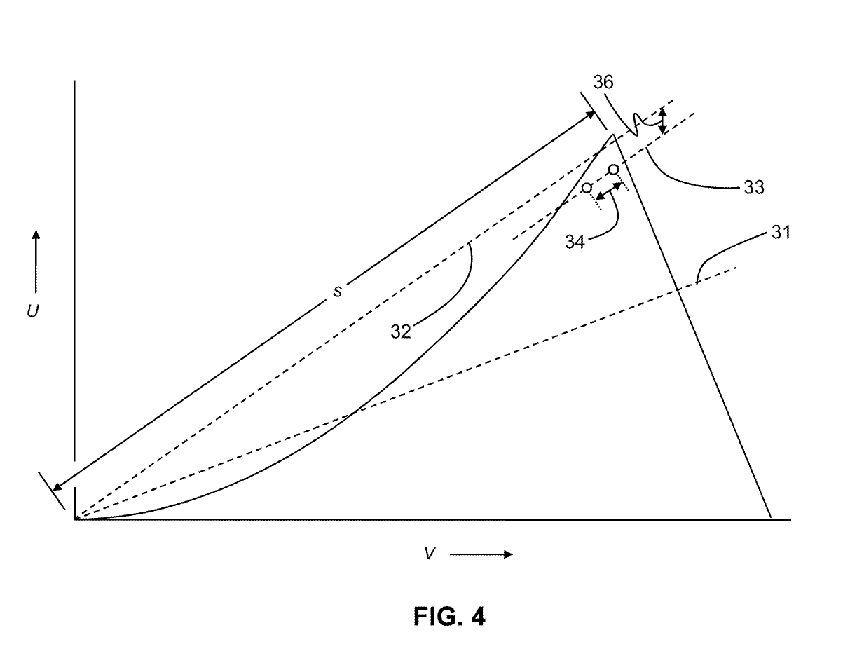

Now continuing discussion of the method 100 (FIG. 7A), once the calibrant peaks have been positively identified and a coarse mass-axis calibration developed (Steps 110 and 112 or the method 200), as described above, the setting of the voltage slope (ΔU/ΔV) is re-adjusted to a value so as to produce a spectrum having nearly constant peak widths (Step 114). The remaining fine calibration steps are similar to the steps (b) and (c) as described by Grothe. Specifically, if some of the peaks are no longer visible in a new mass spectrum at the new voltage slope setting, then the setting of the DC voltage offset (adjustment 36 in FIG. 4) is adjusted (Step 116) to bring the peaks back into view in subsequent spectra. Because of the asymmetry of the apex of Mathieu diagram, this DC voltage offset adjustment can create slight shifts in observed peak positions. Therefore, the mass axis calibration may also need to be adjusted to bring the peaks back to their known values. Steps 114 and 116 may include repeated acquisition of mass spectra (i.e., repeated mass scanning) during which time one or more voltages are adjusted by a user and the effects of the adjustments are observed by the user. The curve fitting procedure described by Grothe, which employs fitting to monoisotopic peaks as well as isotopic variants, may be employed at the last, fine-calibration stage of the mass axis (Step 118) to develop the final precise mass axis calibration. Either or both of the DC voltage offset fine adjustment and the mass-axis calibration fine adjustment may be performed piecewise, on local segments or sections of the full mass spectrum, with the result that the m/z values are only approximately linear in the instrumental variable, s, over the entire spectrum. During this step, the previously-determined coarse calibration is employed to identify the peaks that are being modeled. The coarse calibration provides the m/z positions of the peaks within a certain error range that is sufficient to identify the peaks. Since more-precise m/z positions of the peaks are known, a priori, the curve fitting procedure adjusts one or more calibration parameters such that the resulting final calibration provides the m/z positions of the peaks with smaller error. Subsequently, the quadrupole mass filter may be operated (Step 120) to obtain mass spectra of samples using the final m/z calibration, the adjusted voltage, U, and the adjusted voltage ratio, U/V.

The discussion included in this application is intended to serve as a basic description. Although the invention has been described in accordance with the various embodiments shown and described, one of ordinary skill in the art will readily recognize that there could be variations to the embodiments and those variations would be within the spirit and scope of the present invention. The reader should be aware that the specific discussion may not explicitly describe all embodiments possible; many alternatives are implicit. Accordingly, many modifications may be made by one of ordinary skill in the art without departing from the scope and essence of the invention. Neither the description nor the terminology is intended to limit the scope of the invention. Any patents, patent applications, patent application publications or other literature mentioned herein are hereby incorporated by reference herein in their respective entirety as if fully set forth herein.

What is claimed is:

1. A method for performing a calibration of mass-to-charge ratio (m/z) values of mass spectra generated by a quadrupole mass filter comprising:
(a) infusing a calibrant material into the mass spectrometer, wherein the calibrant material comprises a compound or a mixture compounds known to generate C mass spectral peaks at respective known m/z values;
(b) generating an uncalibrated mass spectrum of the calibrant material comprising P observed mass spectral peaks, where P°>° C.,
(c) calculating, for each known calibrant m/z value, a set of P assumed values of a control parameter, s, that is used to control m/z values of ions transmitted through the quadrupole mass filter, wherein each assumed value corresponds to a respective one of the observed mass spectral peaks and is calculated under an assumption that said observed mass spectral peak is a calibrant peak that occurs at said known calibrant m/z value;
(d) logically assembling a scatter plot of a plurality of points, each point having a coordinate representing a known m/z value and another coordinate representing a one of the assumed s values calculated for the known m/z value;
(e) finding a straight line that passes, within error, through an origin of the scatter plot and through exactly one point of the scatter plot at each known m/z value; and
(f) determining a calibration parameter, α, from the slope of the straight line, wherein the calibrated m/z values are given by the equation (m/z)=α×s.

2. A method as recited in claim 1,
wherein the logical assembling of the scatter plot includes generating a physical plot of the plurality of points, and
wherein the finding of the straight line includes orienting a straight edge to align with the scatter plot origin and with exactly one point at each known m/z value.

3. A method as recited in claim 1,
wherein the logical assembling of the scatter plot comprises storing, in computer readable memory, an array or data structure mathematically representing the positions of the points of the scatter plot in a two dimensional data space, and
wherein the finding of the straight line includes mathematically analyzing the array or data structure using a machine-vision straight-line-finding algorithm.

4. A method as recited in claim 3, wherein the machine-vision straight-line-finding algorithm comprises calculating a Hough transform or a Radon transform of the positions of the points.

5. A method as recited in claim 3,
wherein the logical assembling of the scatter plot comprises storing, in computer readable memory, an array mathematically representing the positions of the points of the scatter plot in a two dimensional data space, and
the finding of the straight line comprises:
(i) calculating, for each grouping of a first known m/z value and a second known m/z value and for a plurality of pairs of the points, each pair of points consisting of one point associated with the first m/z value and one point associated with the second m/z value, a slope and an axis intercept of a line passing through the pair of points;
(ii) for those pairs of points for which the axis intercepts are equal to zero, within error, generating or calculating a histogram representing the number of times a slope value is calculated within each of a number slope ranges; and
(iii) determining the straight line as a line through the scatter plot origin having a slope corresponding to a histogram maximum value.

6. A method as recited in claim 3, further comprising operating the quadrupole mass filter to obtain mass spectra of samples using a calibration that employs the determined calibration parameter.

7. A method for performing a calibration of mass-to-charge (m/z) ratio values and widths of peaks of mass spectra generated by a quadrupole mass filter comprising:
(a) performing a first calibration of mass-to-charge ratio (m/z) values by the method of claim 1, wherein the first calibration is a coarse calibration;
(b) adjusting a control parameter that controls a ratio, U/V, between a non-oscillatory voltage, U, and an oscillatory voltage, V, applied to the quadrupole mass filter to a value such that a mass spectrum obtained subsequent to the adjustment comprises approximately constant peak widths;
(c) adjusting the voltage, U, applied to the quadrupole mass filter such that a mass spectrum obtained subsequent to the U adjustment comprises constant peak widths; and
(j) generating a final m/z calibration by adjusting the control parameter, s, such that a mass spectrum obtained subsequent to the s adjustment fits a model spectrum, wherein the model spectrum employs the coarse calibration to identify peaks.

8. A method as recited in claim 7, further comprising operating the quadrupole mass filter to obtain mass spectra of samples using that employs the final m/z calibration, the adjusted voltage, U, and the adjusted voltage ratio, U/V.

9. A method for performing a calibration of mass-to-charge (m/z) ratio values and widths of peaks of mass spectra generated by a quadrupole mass filter comprising:
(a) performing a first calibration of mass-to-charge ratio (m/z) values by the method of claim 5, wherein the first calibration is a coarse calibration;
(b) adjusting a control parameter that controls a ratio, U/V, between a non-oscillatory voltage, U, and an oscillatory voltage, V, applied to the quadrupole mass filter to a value such that a mass spectrum obtained subsequent to the adjustment comprises approximately constant peak widths;
(c) adjusting the voltage, U, applied to the quadrupole mass filter such that a mass spectrum obtained subsequent to the U adjustment comprises constant peak widths; and
(j) generating a final m/z calibration by adjusting the control parameter, s, such that a mass spectrum obtained subsequent to the s adjustment fits a model spectrum, wherein the model spectrum employs the coarse calibration to identify peaks.

10. A method as recited in claim 7, further comprising operating the quadrupole mass filter to obtain mass spectra of samples using a calibration that employs the determined calibration parameter.
